(19) United States
(12) Patent Application Publication
(10) Pub. No.: US 2025/0044494 A1
(43) Pub. Date: Feb. 6, 2025

(54) LIGHT GUIDE PLATE AND BACKLIGHT MODULE

(71) Applicants: BOE Optical Science and Technology Co., Ltd., Suzhou, Jiangsu (CN); BOE Technology Group Co., Ltd., Beijing (CN)

(72) Inventors: Wei DONG, Beijing (CN); Shijun ZHAO, Beijing (CN); Jun WANG, Beijing (CN)

(21) Appl. No.: 18/720,591

(22) PCT Filed: Dec. 20, 2021
(86) PCT No.: PCT/CN2021/139771

§ 371 Date: Jun. 14, 2024

(51) Int. Cl. F21V 8/00

(52) U.S. Cl. CPC G02B 6/0036; G02B 6/0088; G02B 6/009

(57) ABSTRACT

A light guide plate and a backlight module, including: a light incident surface; a first side surface, the first side surface arranged opposite the light incident surface; a light exiting surface connecting the light incident surface and the first side surface; a bottom surface arranged opposite the light exiting surface, where the bottom surface connects with the light incident surface and the first lateral surface; a second side surface connecting the light incident surface, the first side surface, the bottom surface and the light exiting surface; a third side surface arranged opposite the second side surface, and the third side surface connects with the light incident surface, the first side surface, the bottom surface and the light exiting surface. The bottom surface has a plurality of strip-shaped concave structures, and at least one convex structure protruding outwards from the bottom surface is provided between adjacent concave structures.

### CROSS REFERENCE TO RELATED APPLICATIONS

This application is a national phase entry under 35 U.S.C. § 371 of International Application No. PCT/CN2021/139771, filed on Dec. 20, 2021, the entire content of which is incorporated herein by reference.

### TECHNICAL FIELD

The disclosure relates to the field of optical elements, and in particular to a light guide plate and a backlight module.

### BACKGROUND

Light Guide Plate (LGP) is an important component of the backlight module. The function of the light guide plate is to guide the light emitted by dispersed point light sources or linear light sources to emit from a plane (i.e., the light exiting surface of the light guide plate) to form an area light source.

### SUMMARY

Embodiments of the disclosure provide a light guide plate and a backlight module. The specific solutions are as follows.

Embodiments of the disclosure provide a light guide plate, including: a light incident surface; a first side surface, where the first side surface is arranged opposite to the light incident surface; a light exiting surface, where the light exiting surface connects with the light incident surface and the first side surface; a bottom surface, where the bottom surface is arranged opposite to the light exiting surface, and the bottom surface connects with the light incident surface and the first side surface; a second side surface, where the second side surface connects with the light incident surface, the first side surface, the bottom surface and the light exiting surface; and a third side surface, where the third side surface is arranged opposite to the second side surface, and the third side surface connects with the light incident surface, the first side surface, the bottom surface and the light exiting surface. A direction from a center point of the light incident surface to a center point of the first side surface is indicated as a first direction, and a direction from a center point of the second side surface to a center point of the third side surface is indicated as a second direction; the bottom surface is provided with a plurality of spaced strip-shaped concave structures extending along the first direction and arranged along the second direction, and at least one convex structure protruding from the bottom surface is arranged between adjacent concave structures.

In some embodiments, in the above-mentioned light guide plate provided by embodiments of the disclosure, each convex structure is a strip-shaped structure extending along the first direction.

In some embodiments, in the above-mentioned light guide plate provided by embodiments of the disclosure, one convex structure is provided between the adjacent concave structures, and the convex structure is in contact with the concave structure, or the bottom surface is exposed between the convex structure and the concave structure.

In some embodiments, in the above-mentioned light guide plate provided by embodiments of the disclosure, multiple convex structures are provided between the adjacent concave structures; and the convex structure is in contact with the concave structure, and the convex structures between the adjacent concave structures are in contact with each other. Or the bottom surface is exposed between the convex structure and the concave structures, and is exposed between the convex structures between the concave structures.

In some embodiments, in the above-mentioned light guide plate provided by embodiments of the disclosure, maximum heights of the convex structures are same or different.

In some embodiments, in the above-mentioned light guide plate provided by embodiments of the disclosure, cross-sectional shapes of the convex structures along the second direction are same.

In some embodiments, in the above-mentioned light guide plate provided by embodiments of the disclosure, the cross-sectional shape of the convex structures along the second direction include a cylindrical lens shape, a semicircle, a cylindrical shape, or a rectangle.

In some embodiments, in the above-mentioned light guide plate provided by embodiments of the disclosure, a width of the convex structure in the second direction decreases gradually along the first direction.

In some embodiments, in the above-mentioned light guide plate provided by embodiments of the disclosure, a width of the concave structure in the second direction increases gradually along the first direction.

In some embodiments, in the above-mentioned light guide plate provided by embodiments of the disclosure, a sum of the width of the concave structure in the second direction and the width of the convex structure in the second direction is unchanged along the first direction.

In some embodiments, in the above-mentioned light guide plate provided by embodiments of the disclosure, each strip-shaped concave structure includes a plurality of spaced concave portions along the first direction, and the concave portions curve inward the bottom surface; and in each strip-shaped concave structure, a convex portion is arranged between adjacent concave portions, and a surface of the convex portion is flush with the bottom surface.

In some embodiments, in the above-mentioned light guide plate provided by embodiments of the disclosure, each strip-shaped concave structure includes a plurality of spaced concave portions along the first direction, and the concave portions curve inward the bottom surface; and in each strip-shaped concave structure, a convex portion is arranged between adjacent concave portions, and a surface of the convex portion is provided with a plurality of teeth structures. Each teeth structure includes a first protrusion and a first concave land alternately arranged along the second direction, where a surface of the first protrusion is flush with the bottom surface, and a concave depth of the first concave land is smaller than a maximum concave depth of the concave portion.

In some embodiments, in the above-mentioned light guide plate provided by embodiments of the disclosure, in a cross section of the concave portion along the first direction, a concave depth of the concave portion is first increasing and then decreasing.

In some embodiments, in the above-mentioned light guide plate provided by embodiments of the disclosure, the increasing is a linear increasing and the decreasing is a linear decreasing.

In some embodiments, in the above-mentioned light guide plate provided by embodiments of the disclosure, a length of a portion with increasing concave depth is same as or different from a length of a portion with decreasing concave depth.

In some embodiments, in the above-mentioned light guide plate provided by embodiments of the disclosure, the increasing is a nonlinear increasing and the decreasing is a linear decreasing.

In some embodiments, in the above-mentioned light guide plate provided by embodiments of the disclosure, a length of a portion in the nonlinear increasing is greater than a length of a portion in the linear decreasing.

In some embodiments, in the above-mentioned light guide plate provided by embodiments of the disclosure, a cross-sectional shape of the a portion in the nonlinear increasing along the first direction is a curved surface; and the curved surface curves towards a side of the light exiting surface, or the curved surface curves towards a side facing away from the light exiting surface.

In some embodiments, in the above-mentioned light guide plate provided by embodiments of the disclosure, a connection point between a portion with increasing concave depth and a portion with decreasing concave depth is indicated as a first connection point, and a connecting line segment between an end far away from the first connection point in the portion with increasing concave depth and an end far away from the first connection point in the portion with decreasing concave depth is indicated as a reference line segment; where, an angle between the portion with increasing concave depth and the reference line segment ranges from 0.5° to 50°, and an angle between the portion with decreasing concave depth and the reference line segment ranges from 30° to 90°.

In some embodiments, in the above-mentioned light guide plate provided by embodiments of the disclosure, a shape and size of a cross-section of each concave portion along the first direction are the same.

In some embodiments, in the above-mentioned light guide plate provided by embodiments of the disclosure, the light exiting surface is provided with a plurality of second protrusions extending along the first direction and arranged along the second direction; and a shape of the second protrusion is cylindrical lens shaped.

In some embodiments, in the above-mentioned light guide plate provided by embodiments of the disclosure, the plurality of second protrusions are closely arranged, or the plurality of second protrusions are arranged at intervals.

In some embodiments, in the above-mentioned light guide plate provided by embodiments of the disclosure, the light exiting surface is further provided with a plurality of light-adjusting microstructures arranged on surfaces of the second protrusions, and the light-adjusting microstructures are configured to adjust an angle of the light emitted from the light exiting surface.

In some embodiments, in the above-mentioned light guide plate provided by embodiments of the disclosure, a shape of the light-adjusting microstructure includes a cylindrical shape, a triangular pyramid, or a circle.

Correspondingly, embodiments of the disclosure further provide a backlight module, including: the light guide plate as described in any one of the above embodiments; a light source at a side of the light incident surface of the light guide plate; a reflective sheet at a side of the bottom surface of the light guide plate; and a prism sheet at a side of the light exiting surface of the light guide plate.

### BRIEF DESCRIPTION OF FIGURES

FIG. 1 is a three-dimensional schematic diagram of a light guide plate provided by an embodiment of the disclosure.

FIG. 2 is an enlarged view of a dotted box in FIG. 1.

FIG. 3 is a cross-sectional view along a direction CC′ in FIG. 1.

FIG. 4 shows the convex structures designed as cylindrical structures with unequal heights.

FIG. 5 shows the convex structures designed as lenticular lens structures with unequal heights.

FIG. 6A shows that the cross-sectional shape of the convex structure along the second direction is lenticular lens shaped.

FIG. 6B shows that the cross-sectional shape of the convex structure along the second direction is a semicircle.

FIG. 6C shows that the cross-sectional shape of the convex structure along the second direction is cylinder-shaped.

FIG. 6D shows that the cross-sectional shape of the convex structure along the second direction is a rectangle.

FIG. 7 shows an enlarged view of the dotted box in FIG. 1.

FIGS. 8A to 8E shows various three-dimensional schematic diagrams of the concave portion in FIG. 2.

FIGS. 9A to 9E shows cross-sectional views along the first direction of the concave portions shown respectively in FIGS. 8A to 8E.

FIG. 9F shows another cross-sectional view of the concave portion along the first direction.

FIG. 10 shows a partial enlarged three-dimensional view of the light guide plate.

FIG. 11 shows another three-dimensional schematic diagram of the light guide plate.

FIG. 12 shows a cross-sectional view along the direction EE′ in FIG. 11.

FIG. 13 shows that a shape of the light-adjusting microstructure is a triangular pyramid.

FIG. 14 shows that a shape of the light-adjusting microstructure is a circle.

FIG. 15 shows the measured brightness data at the front viewing angle of a light guide plate with dots by laser or dotting on the bottom surface provided in the related art, paired with an ordinary prism sheet, and the above-mentioned light guide plate provided by embodiments of the disclosure, paired with a special prism sheet.

FIG. 16 shows the test brightness data of a light guide plate with dots by laser or dotting on the bottom surface provided in the related art at different angles.

FIG. 17 shows the test brightness data of the light guide plate provided by embodiments of the disclosure at different angles.

FIG. 18 shows a schematic structural diagram of a backlight module provided by an embodiment of the disclosure.

### DETAILED DESCRIPTION

In order to make the purpose, technical solutions and advantages of embodiments of the disclosure more clear, the technical solutions of embodiments of the disclosure will be clearly and completely described below in conjunction with the drawings of embodiments of the disclosure. Obviously, the described embodiments are some, but not all, of embodiments of the disclosure. And the embodiments and features in embodiments of the disclosure may be combined with each other without conflict. Based on the described embodiments of the disclosure, all other embodiments obtained by those of ordinary skill in the art without creative efforts fall within the scope of the disclosure.

Unless otherwise defined, technical terms or scientific terms used in this disclosure shall have the usual meaning understood by a person with ordinary skill in the art to which this disclosure belongs. Words such as “including” or “comprising” refer to the components or objects that appear before the word, including those listed after the word and their equivalents, without excluding other components or objects. Words such as “connected” or “connecting” are not limited to physical or mechanical connections, but may include electrical connections, whether direct or indirect. Words such as “inside”, “outside”, “up”, “down” are only used to express relative positional relationships. When the absolute position of the described object changes, the relative positional relationship may also change accordingly.

It should be noted that the sizes and shapes of the figures in the drawings do not reflect true proportions and are only intended to illustrate the disclosure. And the same or similar reference numbers throughout represent the same or similar elements or elements with the same or similar functions.

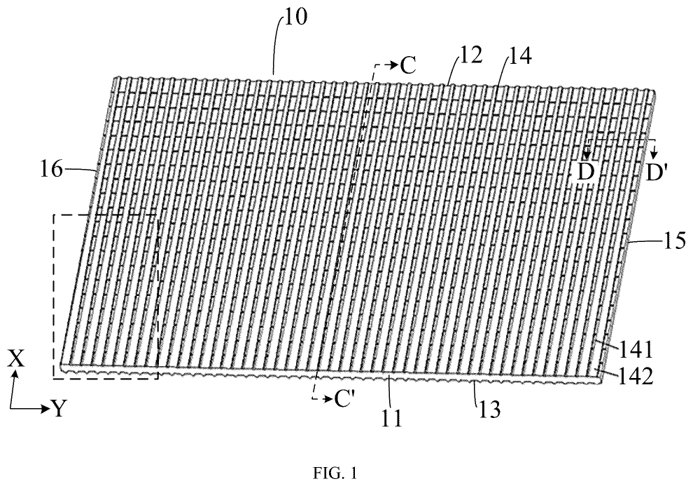

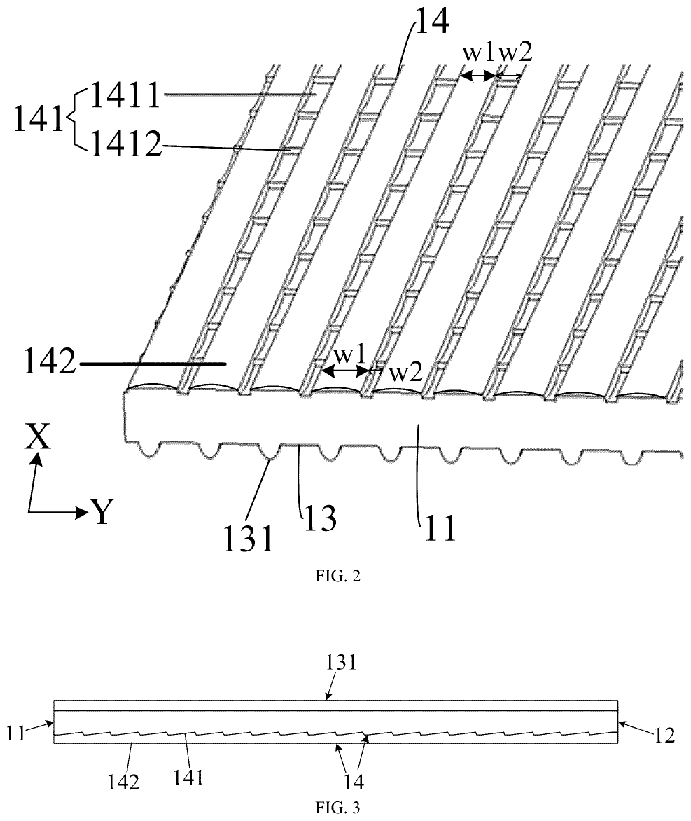

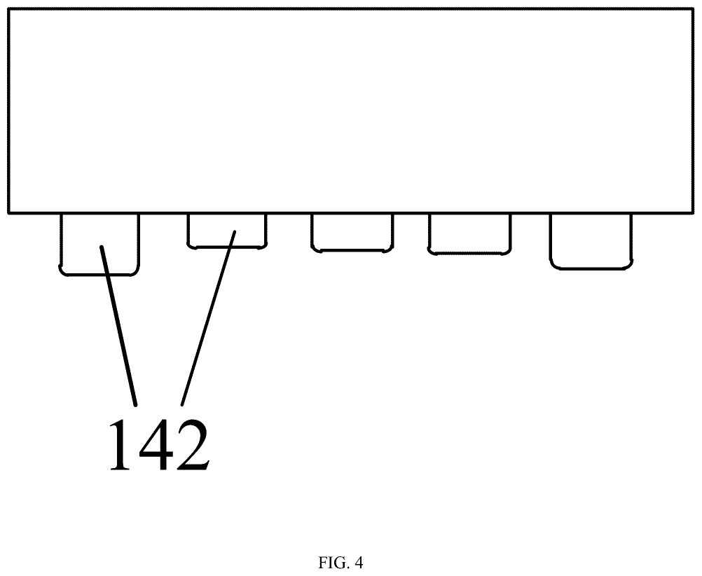

Embodiments of the disclosure provide a light guide plate 10, as shown in FIGS. 1 to 3. FIG. 1 is a three-dimensional schematic diagram of the light guide plate 10. FIG. 2 is an enlarged view of the dotted box in FIG. 1. FIG. 3 is a cross-sectional view along the direction CC′ in FIG. 1. In order to clearly illustrate the bottom structure of the light guide plate 10, the bottom surface is shown at the top in FIGS. 1 to 3 for illustration. The light guide plate includes:
a light incident surface 11;
a first side surface 12, where the first side surface 12 is arranged opposite to the light incident surface 11;
a light exiting surface 13, where the light exiting surface 13 connects with the light incident surface 11 and the first side surface 12;
a bottom surface 14, where the bottom surface 14 is arranged opposite to the light exiting surface 13, and the bottom surface 14 connects with the light incident surface 11 and the first side surface 12;
a second side surface 15, where the second side surface 15 connects with the light incident surface 11, the first side surface 12, the bottom surface 14 and the light exiting surface 13;
a third side surface 16, where the third side surface 16 is arranged opposite to the second side surface 15, and the third side surface 16 connects with the light incident surface 11, the first side surface 12, the bottom surface 14 and the light exiting surface 13; where:
a direction from a center point of the light incident surface 11 to a center point of the first side surface 12 is a first direction X, and a direction from a center point of the second side surface 15 to a center point of the third side surface 16 is a second direction Y;
the bottom surface 14 is provided with a plurality of spaced strip-shaped concave structures 141 extending along the first direction X and arranged along the second direction Y, and at least one convex structure 142 protruding from the bottom surface 14 is arranged between adjacent concave structures 141.

The bottom surface is a datum surface for the concave and/or convex structure(s), and can also refer to a plane corresponding to the datum surface.

The above-mentioned light guide plate 10 provided by embodiments of the disclosure is generally used in a backlight module. The backlight module further includes a light source at a side of the light incident surface 11 of the light guide plate 10, a reflective sheet at a side of the bottom surface 14 of the light guide plate 10, and a prism sheet at a side of the light exiting surface 13 of the light guide plate 10. The concave structure 141 is mainly used to adjust the direction of the light, so that after the light exits the light exiting surface 13 of the light guide plate 10, it is more consistent with the best incident light angle of the prism sheet, to achieve the purpose of increasing forward brightness. The convex structure 142 is mainly used to provide a certain air spacing between the light guide plate 10 and the reflective sheet, and get a better refraction effect by utilizing the different refractive indexes of the air and the light guide plate 10 materials, thereby increasing the forward brightness and improving the production yield. In addition, the convex structure 142 guides the light emitted by the light source along the convex structure 142 to a side of the light guide plate 10 far away from the light source, thereby improving the optical utilization efficiency.

It should be noted that the concave structure 141 is a structure that curves inward the bottom surface 14 of the light guide plate 10, and the convex structure 142 is a structure that curves outward the bottom surface 14 of the light guide plate 10.

In some embodiments, in the above-mentioned light guide plate provided by embodiments of the disclosure, as shown in FIGS. 1 and 2, each convex structure 142 may be a strip-shaped structure extending along the first direction X.

In some embodiments, in the above-mentioned light guide plate provided by embodiments of the disclosure, as shown in FIGS. 1 and 2, the number of the convex structure 142 between adjacent concave structures 141 is one, and the convex structure 142 is in contact with the adjacent concave structures 141, that is, the bottom surface 14 is not visible between the convex structure 142 and the concave structure 141. Of course, the bottom surface 14 can also be exposed between the convex structure 142 and the concave structure 141, that is, the bottom surface 14 can be seen between the convex structure 142 and the concave structure 141. Specifically, the convex structure 142 and the concave structure 141 can be designed according to the requirement of light output brightness.

FIGS. 1 and 2 take the number of convex structures 142 between adjacent concave structures 141 being one, and the convex structure 142 being closely arranged with the concave structure 141 as an example. Of course, in some embodiments, in the above-mentioned light guide plate provided by embodiments of the disclosure, the number of convex structures 142 between adjacent concave structures 141 can also be multiple. The convex structures 142 are in contact with the concave structures 141, and the convex structures 142 are in contact with each other. That is, the bottom surface 14 is not visible between the convex structure 142 and the concave structure 141, and between the adjacent convex structures 142. Of course, the bottom surface 14 can be exposed between the convex structure 142 and the adjacent concave structure 141, and can be exposed between the convex structures. That is, the bottom surface 14 can be seen between the convex structure 142 and the concave structure 141 and between the convex structures 142. Specifically, the convex structure 142 and the concave structure 141 can be designed according to the requirement of light output brightness.

Specifically, the convex structures 142 can be made in a variety of ways, such as laser dotting, cutter dotting, etc. The convex structures 142 allow a certain air gap between the light guide plate 10 and the reflective sheet. Since there is a certain difference between the refractive index of air and the refractive index of the light guide plate (commonly used materials such as PMMA and PC), it is more conducive to the refraction of light on the bottom surface 14 of the light guide plate 10, which is beneficial for improving the light utilization efficiency, thereby improving the light efficiency of the light guide plate 10. In addition, the convex structure 142 can reduce the friction between the light guide plate 10 and the reflective sheet, thereby reducing defects during production and assembly.

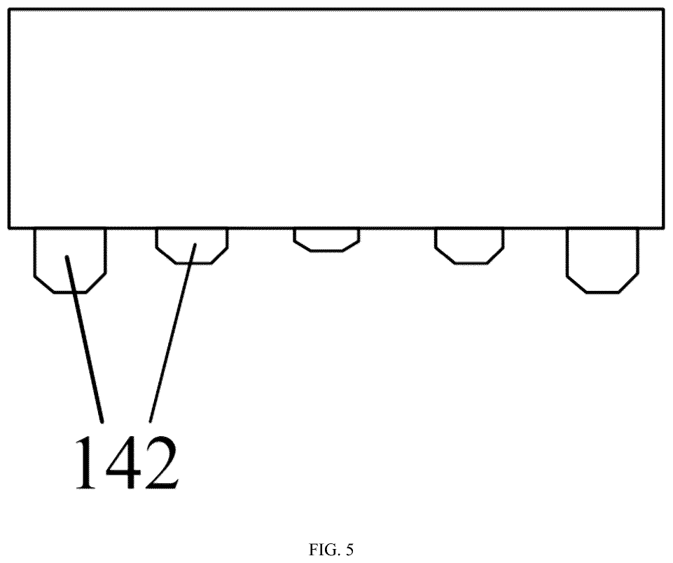

In some embodiments, in the above-mentioned light guide plate provided by embodiments of the disclosure, as shown in FIGS. 1 to 3, the maximum heights of the convex structures 142 can be same; of course, the maximum heights of the convex structures 142 can be different, as shown in FIGS. 4 and 5. FIGS. 4 and 5 are cross-sections view along the direction DD′ in FIG. 1. In order to illustrate the difference in the maximum heights of the convex structures 142, FIGS. 4 and 5 only illustrate the convex structures 142. In fact, there are concave structures 141 between adjacent convex structures 142. That is, the convex structures 142 in FIGS. 4 and 5 are designed with different heights. The design of the convex structures 142 with different heights can further enlarge the air gap between the light guide plate and the reflective sheets, to improve the light recycling efficiency, enhance the overall light output efficiency of the light guide plate, and further improve the yield rate. In addition, when the light guide plate 10 and the reflective sheet are closely attached without any air gap, the reflective sheet will be attached on the bottom surface 14 of the light guide plate 10. Due to the commonly used reflective material being polyethylene terephthalate (PET), which is relatively soft, it is easy to form interference fringes similar to wave shapes caused by attachment in the backlight vision. The convex structure 142 designed in embodiments of the disclosure can effectively solve this problem. In addition, when there are foreign matters in the environment or foreign matters in the reflective sheet itself between the light guide plate 10 and the reflective sheet, if there is no air gap between the light guide plate 10 and the reflective sheet, the foreign matters will abrade the light guide plate 10 or the reflective sheet when the backlight module assembly or thermal expansion and contraction cause relative motion between the two components, resulting in poor visual appearance of black or white spots. However, in embodiments of the disclosure, there can be an air gap between the light guide plate 10 and the reflective sheet by designing the convex structures 142 protruding from the bottom surface 14 of the light guide plate 10. Therefore, the convex structures 142 can effectively solve the problem of foreign matters damaging the light guide plate 10 or the reflective sheet, and the convex structures 142 can also protect the concave structure 141 from being easily damaged.

In some embodiments, in the above-mentioned light guide plate provided by embodiments of the disclosure, as shown in FIGS. 1 and 2, the cross-sectional shapes of convex structures 142 along the second direction Y are the same, which can simplify the manufacturing process. Of course, the cross-sectional shapes of the convex structures 142 along the second direction Y can be different, and the design can be based on actual needs.

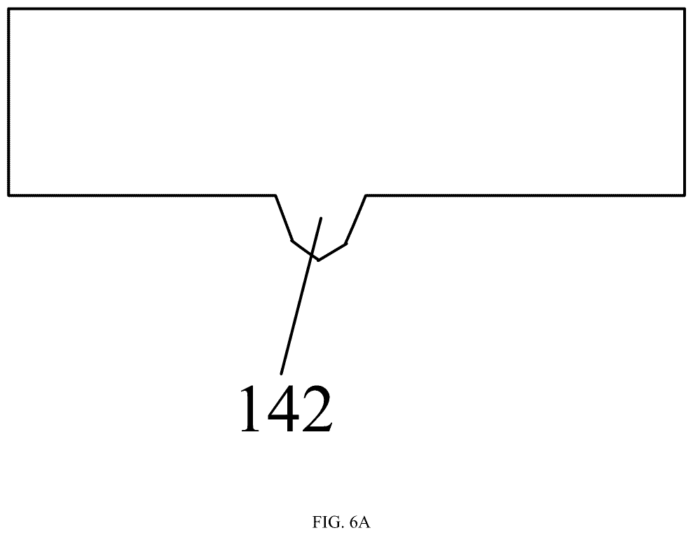

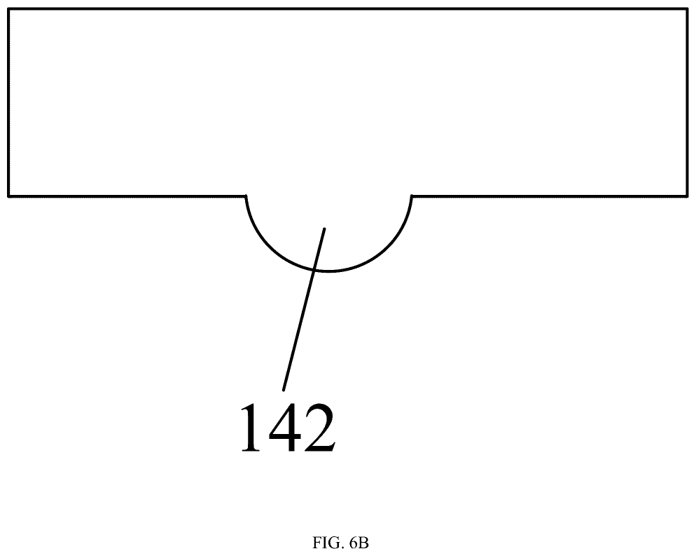

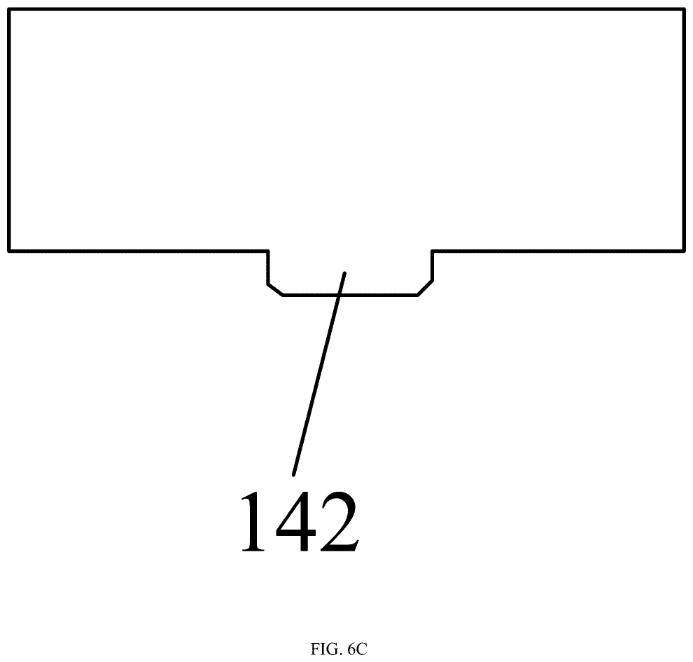

In some embodiments, in the above-mentioned light guide plate provided by embodiments of the disclosure, as shown in FIGS. 1 and 2, the cross-sectional shapes of the convex structures 142 along the second direction Y include but are not limited to a lenticular lens shape, a semicircle, a cylindrical shape, or a rectangle. Specifically, as shown in FIG. 6A, the cross-sectional shape of the convex structure 142 along the second direction Y is lenticular lens shaped; as shown in FIG. 6B, the cross-sectional shape of the convex structure 142 along the second direction Y is a semicircle; as shown in FIG. 6C, the cross-sectional shape of the convex structure 142 along the second direction Y is a cylindrical shape; as shown in FIG. 6D, the cross-sectional shape of the convex structure 142 along the second direction Y is a rectangle.

Specifically, as shown in FIGS. 4 and 5, the convex structures 142 in FIG. 4 are designed as cylindrical structures with unequal heights, and the convex structures 142 in FIG. 5 are designed as lenticular lens structures with unequal heights.

In some embodiments, in the above-mentioned light guide plate provided by embodiments of the disclosure, as shown in FIGS. 1 and 2, the width w1 of the convex structure 142 in the second direction Y decreases gradually along the first direction X, and the width w2 of the concave structure 141 in the second direction Y increases gradually along the first direction X. In this way, by arranging the convex structure 142 with varying width on the bottom surface 14 of the light guide plate 10, the uniformity of the overall light emission of the light guide plate 10 can be adjusted, further improving the light utilization rate.

In some embodiments, in the above-mentioned light guide plate provided by embodiments of the disclosure, as shown in FIGS. 1 and 2, a sum of the width w2 of the concave structure 141 in the second direction Y and the width w1 of the convex structure 142 in the second direction Y is unchanged along the first direction.

In some embodiments, in the above-mentioned light guide plate provided by embodiments of the disclosure, as shown in FIGS. 1 to 3, each of the strip-shaped concave structure 141 includes a plurality of spaced concave portions 1411 that curve inward the bottom surface 14 along the first direction X; and in each strip-shaped concave structure 141, a convex portion 1412 is arranged between adjacent concave portions 1411, and a top surface of the convex portion 1412 can be flush with the bottom surface 14. The specific structures of the concave portion 1411 and the convex portion 1412 can be referred to FIG. 2. The main function of the concave structure 141 is to reflect the light from the light source in the backlight module at different angles and adjust the light emission angle so that the light emission angle meets the optimal light incident angle of the prism sheet.

Specifically, as shown in FIGS. 1 to 3, the concave structure 141 can be produced through a grayscale photolithography process, but is not limited thereto.

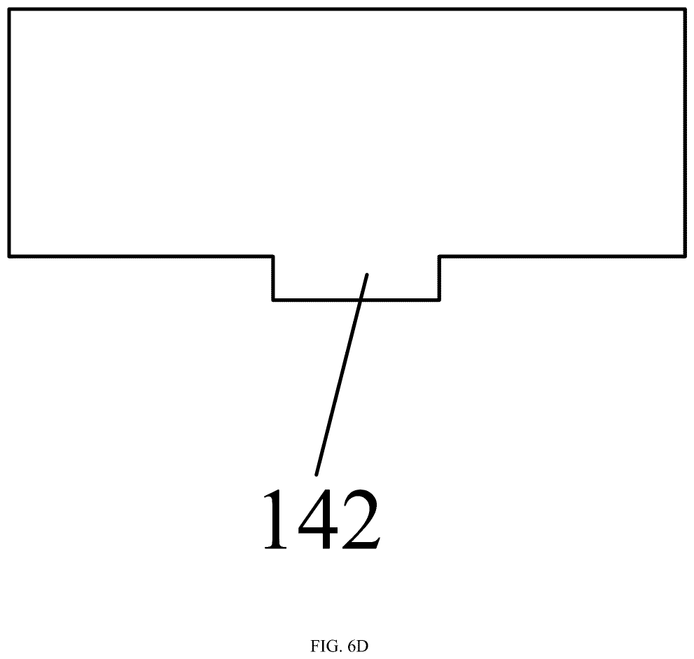

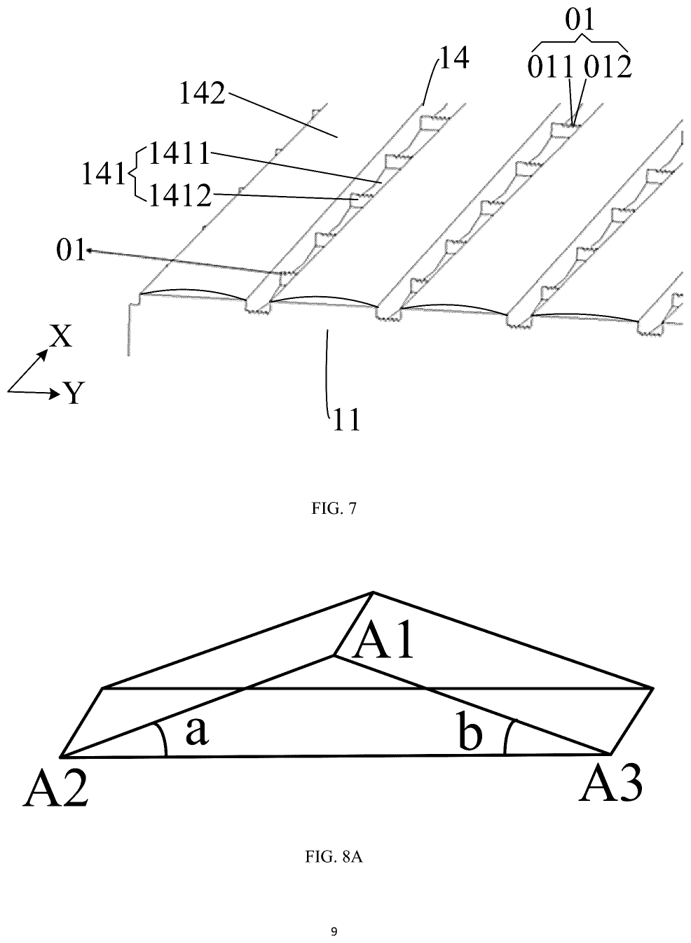

In some embodiments, in the above light guide plate provided by embodiments of the disclosure, as shown in FIG. 7, each of the strip-shaped concave structures 141 includes a plurality of spaced concave portions 1411 along the first direction X which curve inward the bottom surface 14; and in each strip-shaped concave structure 141, a convex portion 1412 is arranged between adjacent concave portions 1411, and a surface of the convex portion 1412 is provided with a plurality of teeth structures 01.

The teeth structure 01 includes a first protrusion 011 and a first concave land 012 alternately arranged along the second direction Y, where a surface of the first protrusion 011 is flush with the bottom surface 14, and a concave depth of the first concave land 012 is smaller than a maximum concave depth of the concave portion 1411. By forming the teeth structure 01 at the convex portion 1412 of the concave structure 141 on the bottom surface 14 of the light guide plate 10, the problem of obvious defects such as bright lines or dark lines can be prevented.

In some embodiments, in the above-mentioned light guide plate provided by embodiments of the disclosure, as shown in FIGS. 1 to 3 and FIG. 7, the shape and size of the cross-section of each concave portion 1411 along the first direction X are the same, which can facilitate the uniform production process.

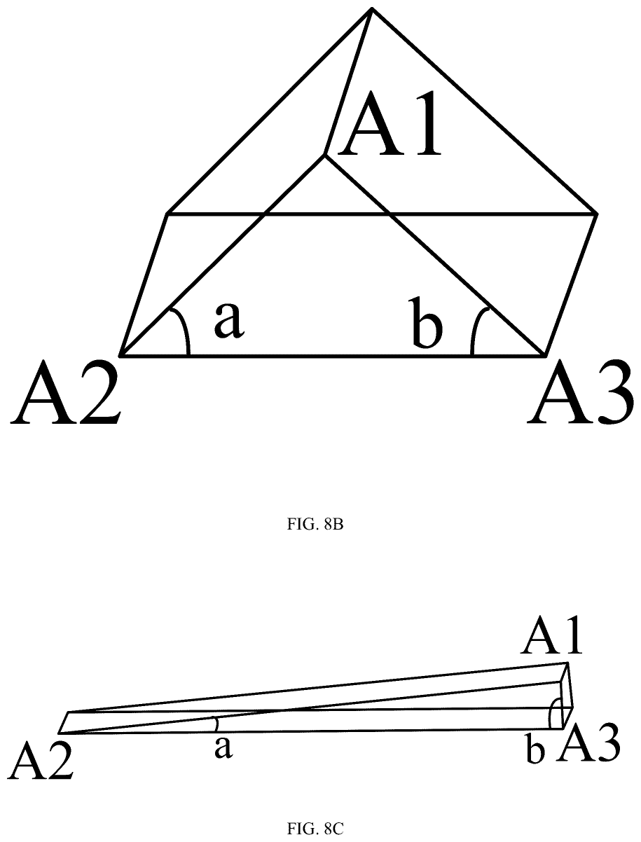

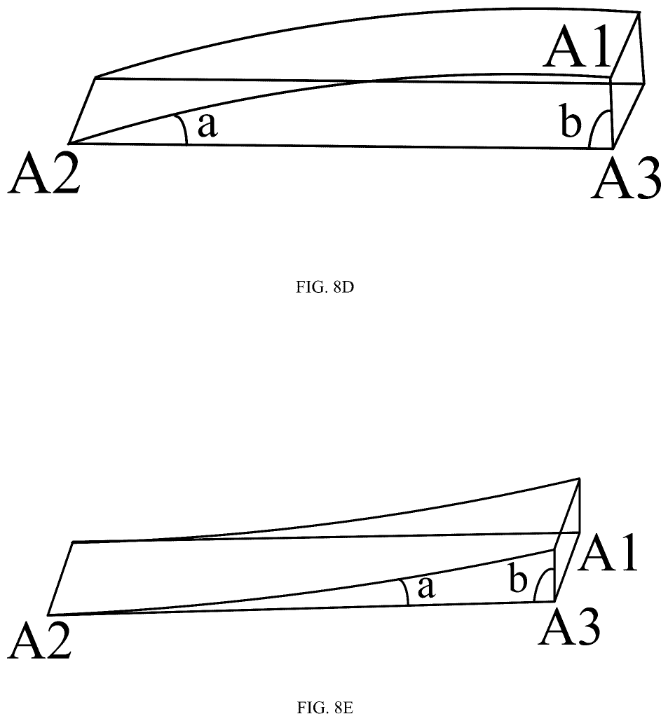

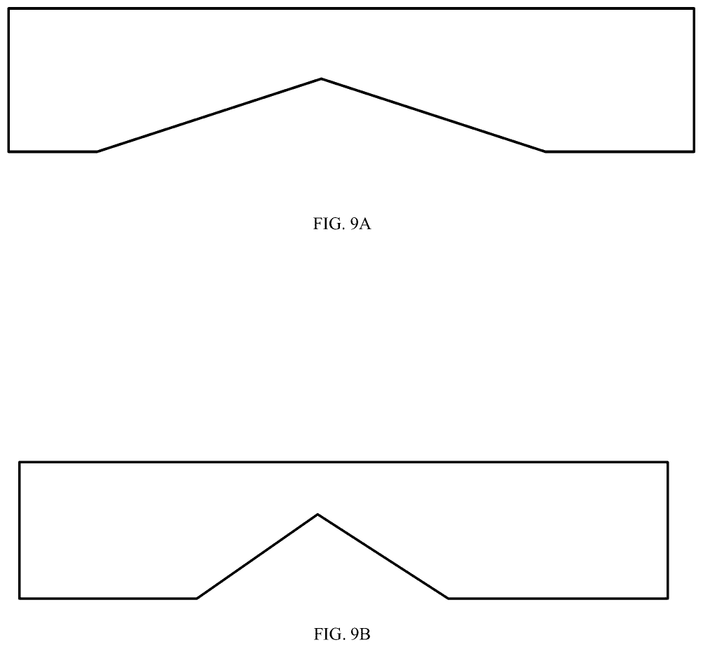

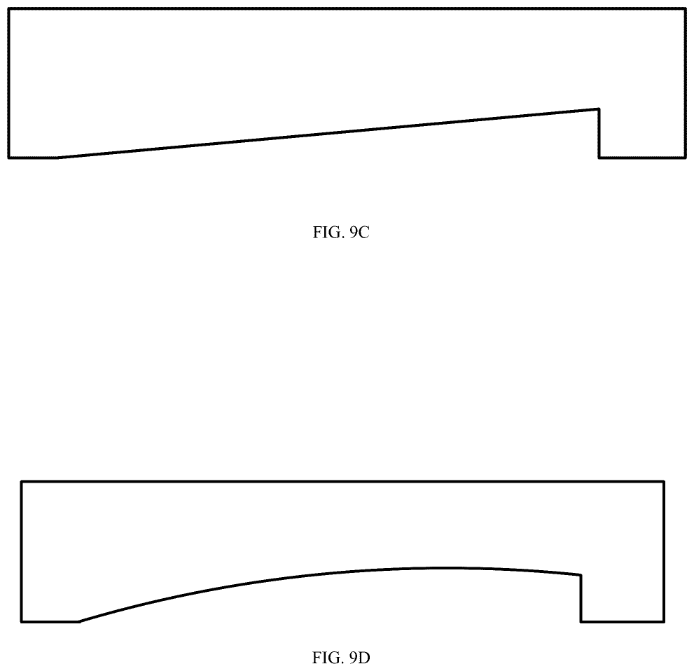

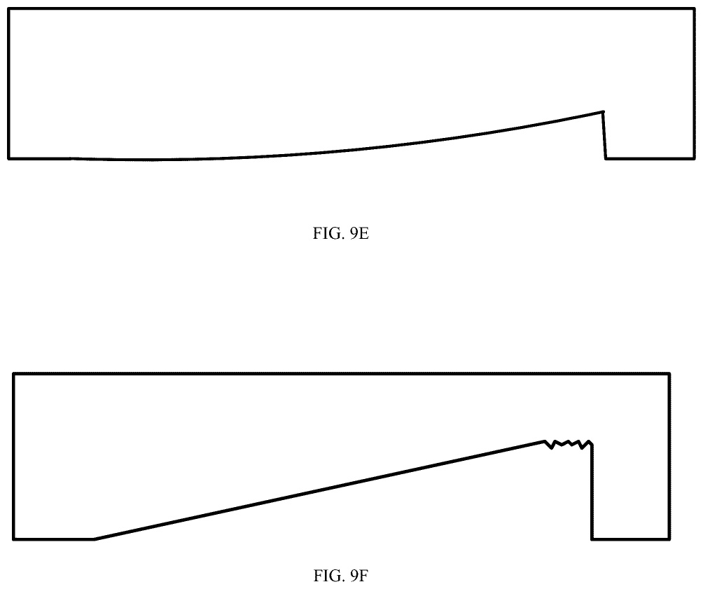

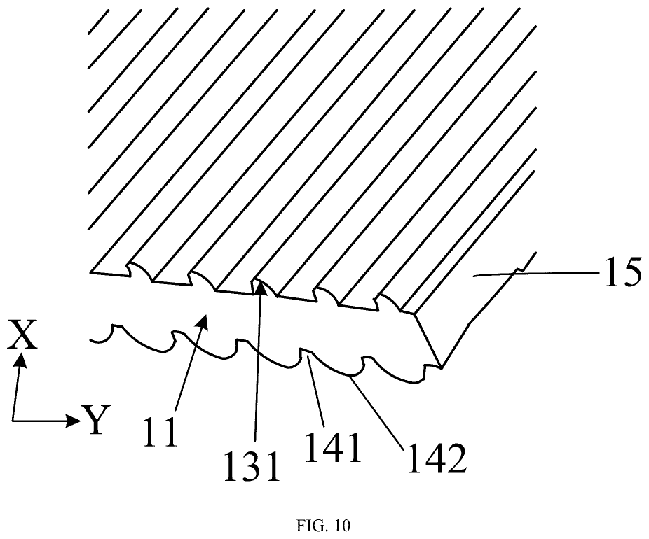

In some embodiments, in the above-mentioned light guide plate provided by embodiments of the disclosure, as shown in FIGS. 8A to 8E, FIGS. 8A to 8E are various three-dimensional schematic diagrams of the concave portion 1411 in FIG. 2, and FIGS. 9A to 9E are cross-sectional views along the first direction X of the concave portions 1411 respectively shown in FIGS. 8A to 8E, the concave depth of the concave portion 1411 first increases and then decreases, which can form a slope for reflecting light in the light guide plate 10, so that the light incident on the light guide plate 10 can be reflected out as much as possible to improve the brightness of the forward light output.

In some embodiments, in the above-mentioned light guide plate provided by embodiments of the disclosure, as shown in FIGS. 8A to 8E and FIGS. 9A to 9E, a connection point between the portion with increasing concave depth and the portion with decreasing concave depth is indicated as the first connection point A1, the connection line segment between the end A2 far away from the first connection point A1 in the portion with increasing concave depth and the end A3 far away from the first connection point A1 in the portion with decreasing concave depth forms the reference line segment A2A3; where the angle between the portion with increasing concave depth and the reference line segment A2A3 is a, and the angle between the portion with decreasing concave depth and the reference line segment A2A3 is b. Specifically, as shown in FIGS. 9A to 9C, the increasing refers to a linear increasing, and the decreasing refers to a linear decreasing. As shown in FIG. 9A and FIG. 9B, the length of the portion with increasing concave depth is the same as the length of the portion with decreasing concave depth. As shown in FIG. 9A, the angle a and the angle b are the same. FIG. 9A shows a left-right symmetrical three-dimensional microstructure. When the light emitted by the light source is incident on a slope formed by the angle a, causing optical phenomena such as light reflection, refraction, and transmission. By adjusting the angle a, the angle of reflected light can be adjusted to achieve the optimal angle of light output. The better the mirror effect of the slope, the greater its effect. Generally, the roughness of the slope mirror needs to be 20 nm and below. Similarly, by adjusting the angle b, the light refracted and transmitted through the angle b can be adjusted. As shown in FIG. 9B, the difference between FIG. 9B and FIG. 9A is that the angles a and b in FIG. 9B are larger than the angles a and b in FIG. 9A. As shown in FIG. 9C, the length of the portion with increasing concave depth is different from the length of the portion with decreasing concave depth. FIG. 9C illustrates that the length of the portion with increasing concave depth is greater than the length of the portion with decreasing concave depth. The angle a and the angle b in FIG. 9C are different. FIG. 9C shows a left-right unsymmetrical three-dimensional microstructure. In all FIGS. 9A to 9C, a slope for reflecting light can be formed in the light guide plate 10 so that the light incident on the light guide plate 10 can be reflected out as much as possible to increase the brightness of the forward light output.

In some embodiments, in the above-mentioned light guide plate provided by embodiments of the disclosure, as shown in FIG. 9D and FIG. 9E, the increasing is a non-linear increasing, and the decreasing is a linear decreasing. Specifically, as shown in FIGS. 9D and 9E, the length of the portion in the nonlinear increasing is greater than the length of the portion in the linear decreasing. The angle a and the angle b in FIG. 9D are different from the angle a and the angle b in FIG. 9E. FIGS. 9D and 9E shows three-dimensional microstructures with left and right asymmetry. Specifically, as shown in FIG. 9D, the cross-sectional shape of the portion in the nonlinear increasing along the first direction X is a curved surface c, the curved surface c curves towards a side of the light exiting surface 13, or as shown in FIG. 9E, the curved surface c curves towards a side facing away from the light exiting surface 13. Both FIG. 9D and FIG. 9E allow a curved slope inside the light guide plate 10 for reflecting light, allowing the light incident on the light guide plate 10 to be reflected out as much as possible, thereby improving the brightness of the forward light output.

Specifically, the cross-sectional shape of the concave portion 1411 along the first direction X can be the structure shown in FIG. 9F. The difference between FIG. 9F and FIG. 9C is that after increasing linearly, there is a section of the area that is flat and then decreases linearly.

It should be noted that the portion with decreasing concave depth in FIGS. 9A to 9F is illustrated by designing it at a 90° angle to the horizontal plane. Of course, the portion with decreasing concave depth in FIGS. 9A to 9F can be designed at an acute angle to the horizontal plane.

In some embodiments, in the above-mentioned light guide plate provided by embodiments of the disclosure, as shown in FIGS. 8A to 8E and FIGS. 9A to 9E, the angle a between the portion with increasing concave depth and the reference line segment A2A3 ranges from 0.5° to 50°, and the angle b between the portion with decreasing concave depth and the reference line segment A2A3 ranges from 30° to 90°. The angles of a and b are designed according to the light output needs.

In some embodiments, in the above light guide plate provided by embodiments of the disclosure, as shown in FIGS. 2, 3 and 10, FIG. 10 is a partially enlarged three-dimensional schematic diagram of the light guide plate 10. The light exiting surface 13 of the light guide plate 10 has a plurality of second protrusions 131 extending along the first direction X and arranged along the second direction Y; and the shape of the second protrusion 131 is a cylindrical lens shape. The main function of the second protrusion 131 is to atomize the profile of the light exiting surface 13 of the light guide plate 10, which can increase the brightness of the light and at the same time improve the ability of the light guide plate 10 to shield foreign matters and solve undesirable defects such as white spots.

Specifically, the second protrusion 131 can be made by precision machining.

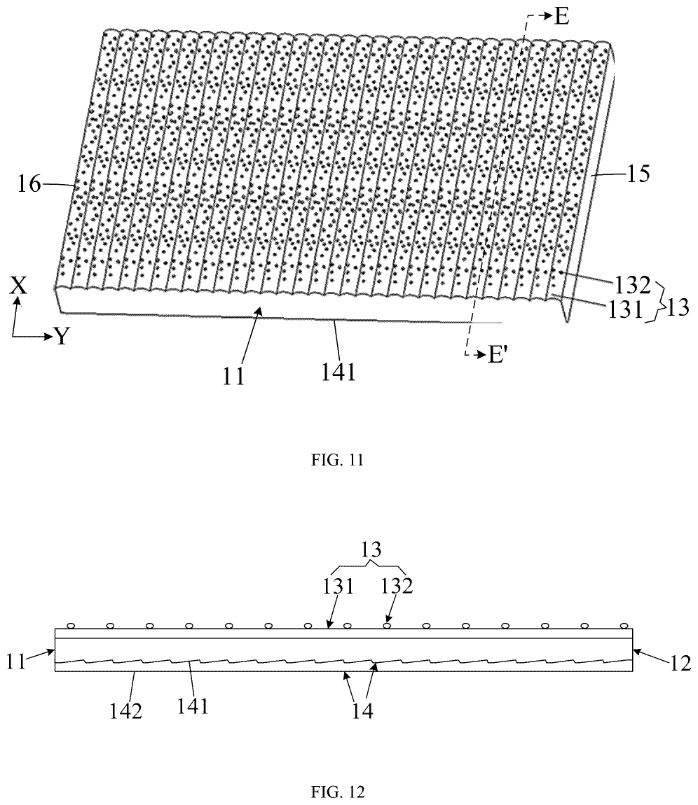

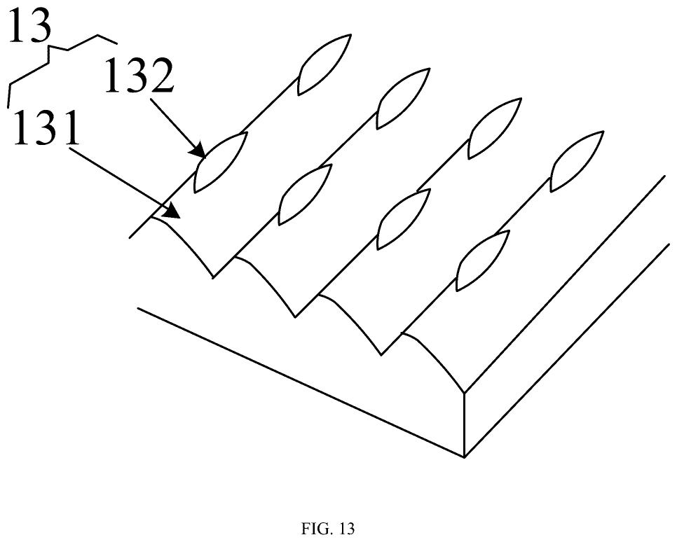

In some embodiments, in the above-mentioned light guide plate provided by embodiments of the disclosure, as shown in FIGS. 2 and 10, the second protrusions 131 are arranged at intervals, or as shown in FIG. 11, the second protrusions 131 are closely arranged, which can be designed according to actual light output requirements.

In some embodiments, in the above light guide plate provided by embodiments of the disclosure, as shown in FIGS. 11 and 12, FIG. 11 is another three-dimensional schematic diagram of the light guide plate 10, and FIG. 12 is a cross-sectional view along the direction EE′ in FIG. 11, the light exiting surface 13 further has a plurality of light-adjusting microstructures 132 on the surfaces of the second protrusions 131. The light-adjusting microstructures 132 are configured to adjust the angle of the light emitted from the light exiting surface 13. Specifically, the light-adjusting microstructures 132 can be produced by grayscale photolithography or laser dotting. The main function of the light-adjusting microstructures 132 is to converge the light distribution through different morphological designs, and at the same time adjust the light emission angle to allow the light emission angle to match the optimal angle of entry of the prism sheet. The light-adjusting microstructures 132 are added to the light exiting surface 13 of the light guide plate 10 to adjust the direction of the light, thereby increasing the forward brightness while increasing the ability to shield defects. After the angle and range of the light emitted from the light guide plate 10 converge, the optimal forward brightness can be achieved by changing the angle of the prism sheet to match the light emission angle of the light guide plate 10, thereby improving the overall light emission efficiency of the light guide plate.

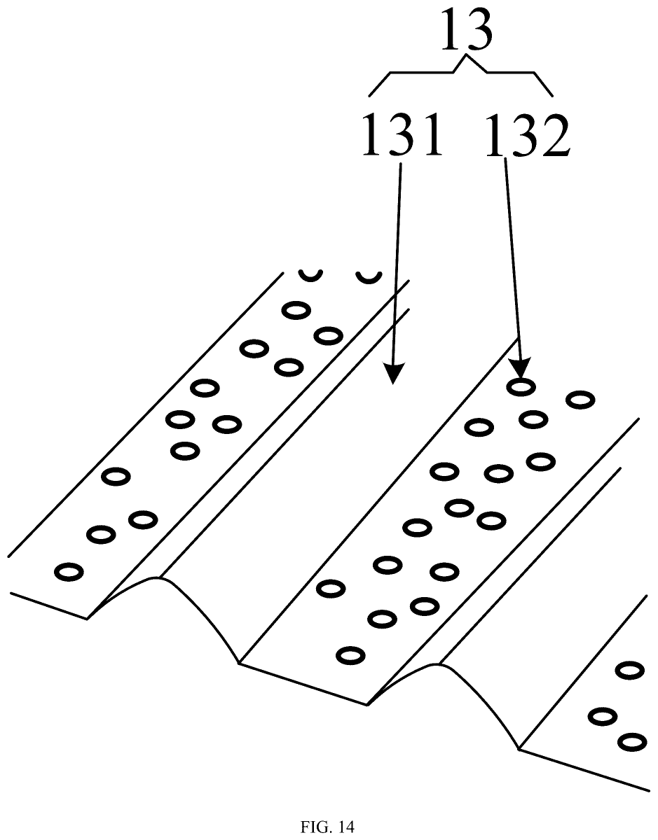

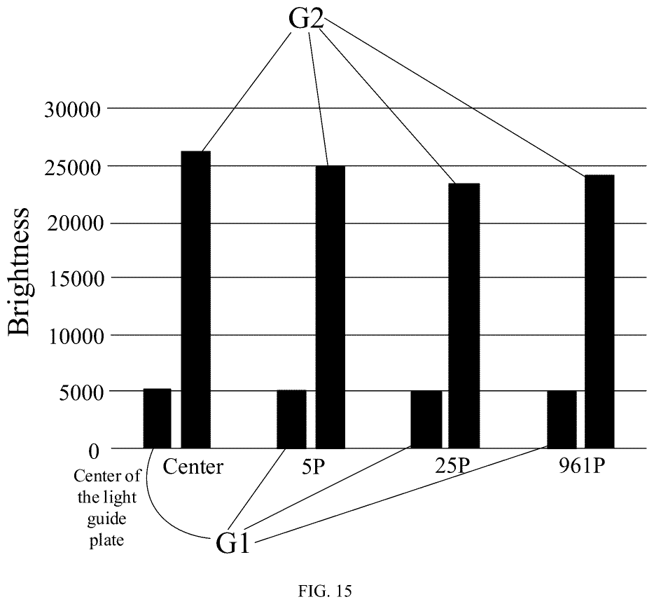

In some embodiments, in the above-mentioned light guide plate provided by embodiments of the disclosure, the shape of the light-adjusting microstructure includes but is not limited to a cylindrical shape, a triangular pyramid shape, or a circular shape. Specifically, FIG. 11 shows that the shape of the light-adjusting microstructure 132 is a cylindrical shape; FIG. 13 shows that the shape of the light-adjusting microstructure 132 is a triangular pyramid; and FIG. 14 shows that the shape of the light-adjusting microstructure 132 is a circle.

In specific implementation, as shown in FIGS. 11, 13 and 14, the light-adjusting microstructures 132 on the light exiting surface 13 can be distributed randomly and are not directly related to the distribution of the convex structures 142 on the bottom surface 14. The light-adjusting microstructures 132 provide the optimal shielding effect through different shapes or distributions.

As shown in FIG. 15, FIG. 15 shows the test brightness data at the front viewing angle of a light guide plate with laser or collision point dots on the bottom surface provided in the related art, paired with an ordinary prism sheet, and the above-mentioned light guide plate 10 provided by embodiments of the disclosure, paired with a special prism sheet. The horizontal axis represents the number of points at different positions under a front viewing angle; “Center” represents the center position of the light guide plate; 5P represents selecting 5 points on the light guide plate, 25P represents selecting 25 points on the light guide plate, and 961P represents selecting 961 points on the light guide plate. The vertical axis represents brightness, G1 represents the brightness measured under a front viewing angle corresponding to the light guide plate provided in the related art, and G2 represents the brightness measured under a front viewing angle corresponding to the light guide plate provided in the disclosure. It can be seen that the brightness under the front viewing angle of embodiments of the disclosure is much greater than the brightness at the front viewing angle in the related art. Therefore, the light guide plate provided by embodiments of the disclosure can improve the forward brightness.

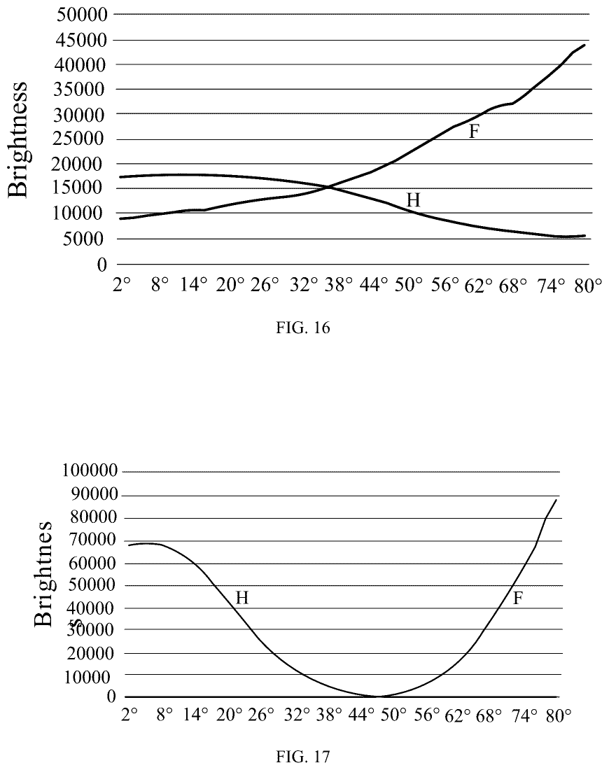

As shown in FIG. 16, FIG. 16 shows the test brightness data at different angles of a light guide plate with laser or collision point dots on the bottom surface provided in the related art. The front view is at 0°, the side view is at a maximum of 90°, and when the angle of light emission from the light guide plate is 80°, the brightness reaches its maximum value (curve F). When the light guide plate with laser or collision point dots is applied in the backlight module (curve H), after the light is refracted by the prism sheet, the maximum value of the brightness is between 0° and 40°, the corresponding brightness is reduced by half between 40° and 80°.

As shown in FIG. 17, FIG. 17 shows the test brightness data of the light guide plate 10 provided by embodiments of the disclosure at different angles. The front view is at 0°, the side view is at a maximum of 90°, and when the angle of light emission from the light guide plate is 80°, the brightness reaches its maximum value (curve F). When the light guide plate is applied in the backlight module (curve H), after the light is refracted by the prism sheet, the angle of light narrows, and the maximum brightness value is between 0° and 10°. At the same time, after 40°, the brightness approaches 0, achieving the effect of collimation.

To sum up, the light guide plate provided by embodiments of the disclosure can improve the forward brightness by arranging a concave structure on the bottom surface of the light guide plate to adjust the direction of light. By arranging a convex structure on the bottom surface of the light guide plate, a certain air gap can be provided to increase optical refraction and improve production and assembly yield. By setting a convex structure on the bottom surface of the light guide plate, the light can be guided forward and improve optical efficiency. By setting a convex structure on the bottom surface of the light guide plate, and changing the width of the convex structure, the overall uniformity of the light guide plate can be adjusted. By adding the second protrusion with the cylindrical lens structure on the light exiting surface of the light guide plate, the brightness can be increased while improving the shielding effect. By adding light-adjusting microstructures on the light exiting surface of the light guide plate, the direction of the light can be adjusted, improving the forward brightness while increasing the ability to shield defects. After the angle and range of the light emitted from the light guide plate converge, the optimal forward brightness can be achieved by changing the angle of the prism sheet to match the light emission angle of the light guide plate and improve the light efficiency of the light guide plate.

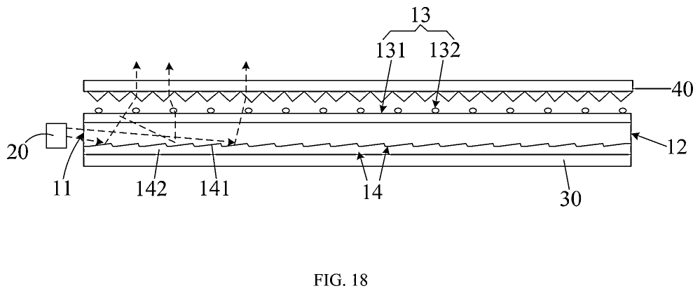

Based on the same inventive concept, embodiments of the disclosure further provide a backlight module, as shown in FIG. 18, including: the light guide plate 10 provided above, a light source 20 at a side of the light incident surface 11 of the light guide plate 10, a reflective sheet 30 at a side of the bottom surface 14 of the light guide plate 10, and a prism sheet 40 at on a side of the light exiting surface 13 of the light guide plate 10. Since the principle of the backlight module solving the problem is similar to that of the aforementioned light guide plate, the implementation of the backlight module can refer to the implementation of the aforementioned light guide plate, and the repetition will not be repeated.

Specifically, the backlight module provided by embodiments of the disclosure may further have other optical film layers, such as diffusion sheets, etc. These film layers are the same as those in the prior art and will not be described in detail here.

In practical applications, the backlight module provided by embodiments of the disclosure is, for example, used in a liquid crystal display.

Embodiments of the disclosure provide a light guide plate and a backlight module. The concave structure on the bottom surface of the light guide plate is mainly used to adjust the direction of the light, so that after the light exits the light exiting surface of the light guide plate 10, it is more consistent with the best incident light angle of the prism sheet, to achieve the purpose of increasing forward brightness. The main purpose of the convex structure on the bottom surface of the light guide plate is to provide a certain air spacing between the light guide plate and the reflective sheet, and provide a better refraction effect by utilizing the different refractive indexes of the air and the light guide plate materials, thereby increasing the forward brightness and improving the production yield. In addition, the convex structure guides the light emitted by the light source along the convex structure to the side of the light guide plate far away from the light source, thereby improving the optical utilization efficiency.

Although the preferred embodiments of the disclosure have been described, those skilled in the art will be able to make additional changes and modifications to these embodiments once the basic inventive concepts are apparent. Therefore, it is intended that the appended claims be construed to include the preferred embodiments and all changes and modifications that fall within the scope of the disclosure.

Evidently those skilled in the art can make various modifications and variations to the disclosure without departing from the spirit and scope of the disclosure. Thus the disclosure is also intended to encompass these modifications and variations therein as long as these modifications and variations to the disclosure come into the scope of the claims of the disclosure and their equivalents.

1. A light guide plate, comprising:
a light incident surface;
a first side surface arranged opposite to the light incident surface;
a light exiting surface, wherein the light exiting surface connects with the light incident surface and the first side surface;
a bottom surface arranged opposite to the light exiting surface, wherein the bottom surface connects with the light incident surface and the first side surface;
a second side surface, wherein the second side surface connects the light incident surface, the first side surface, the bottom surface and the light exiting surface; and
a third side surface arranged opposite to the second side surface, and the third side surface connects with the light incident surface, the first side surface, the bottom surface and the light exiting surface;
wherein a direction from a center point of the light incident surface to a center point of the first side surface is indicated as a first direction, and a direction from a center point of the second side surface to a center point of the third side surface is indicated as a second direction;
the bottom surface is provided with a plurality of spaced strip-shaped concave structures extending along the first direction and arranged along the second direction, and at least one convex structure protruding from the bottom surface is arranged between adjacent concave structures.

2. The light guide plate according to claim 1, wherein each convex structure is a strip-shaped structure extending along the first direction.

3. The light guide plate according to claim 2, wherein a quantity of one convex structure is provided between the adjacent concave structures; and
the convex structure is in contact with the concave structure, or the bottom surface is exposed between the convex structure and the adjacent concave structure.

4. The light guide plate according to claim 2, wherein multiple convex structures are provided between the adjacent concave structures; and
the convex structure is in contact with the concave structure, and the convex structures between the adjacent concave structures are in contact with each other; or
the bottom surface is exposed between the convex structure and the concave structure, and is exposed between the convex structures between the adjacent concave structures.

5. The light guide plate according to claim 2, wherein maximum heights of the convex structures are same or different.

6. The light guide plate according to claim 2, wherein cross-sectional shapes of the convex structures along the second direction are same.

7. The light guide plate according to claim 6, wherein the cross-sectional shape of the convex structures along the second direction comprises a cylindrical lens shape, a semicircle, a cylinder, or a rectangle.

8. The light guide plate according to claim 2, wherein a width of the convex structure in the second direction decreases gradually along the first direction;
a width of the concave structure in the second direction increases gradually along the first direction;
a sum of the width of the concave structure in the second direction and the width of the convex structure in the second direction is unchanged along the first direction.

9. (canceled)

10. (canceled)

11. The light guide plate according to claim 1, wherein each strip-shaped concave structure comprises a plurality of spaced concave portions, curving inward the bottom surface, along the first direction; and
in each strip-shaped concave structure, a convex portion is arranged between adjacent concave portions, and a surface of the convex portion is flush with the bottom surface.

12. The light guide plate according to claim 1, wherein each strip-shaped concave structure comprises a plurality of spaced concave portions, curving inward the bottom surface, along the first direction; and
in each strip-shaped concave structure, a convex portion is arranged between adjacent concave portions, and a surface of the convex portion is provided with a plurality of teeth structures;
each teeth structure comprises a first protrusion and a first concave land alternately arranged along the second direction, wherein a surface of the first protrusion is flush with the bottom surface, and a concave depth of the first concave land is smaller than a maximum concave depth of the concave portion.

13. The light guide plate according to claim 11- or 12, wherein in a cross section of the concave portion along the first direction, a concave depth of the concave portion is first increasing and then decreasing.

14. The light guide plate according to claim 13, wherein the increasing is a linear increasing, and the decreasing is a linear decreasing;
wherein a length of a portion with increasing concave depth is same as or different from a length of a portion with decreasing concave depth.

15. (canceled)

16. The light guide plate according to claim 13, wherein the increasing is a nonlinear increasing, and the decreasing is a linear decreasing;
wherein a length of a portion in the nonlinear increasing is greater than a length of a portion in the linear decreasing.

17. (canceled)

18. The light guide plate according to claim 1716, wherein a cross-sectional shape of the portion in the nonlinear increasing along the first direction is a curved surface; and
the curved surface curves towards a side of the light exiting surface, or the curved surface curves towards a side facing away from the light exiting surface.

19. The light guide plate according to claim 13, wherein a connection point between a portion with increasing concave depth and a portion with decreasing concave depth is indicated as a first connection point, and a connection line segment between an end far away from the first connection point in the portion with increasing concave depth and an end far away from the first connection point in the portion with decreasing concave depth is indicated as a reference line segment;
wherein an angle between the portion with increasing concave depth and the reference line segment ranges from 0.5° to 50°, and an angle between the portion with decreasing concave depth and the reference line segment ranges from 30° to 90°.

20. The light guide plate according to claim 11, wherein a shape and size of a cross-section of each concave portion along the first direction is the same.

21. The light guide plate according to claim 1, wherein the light exiting surface is provided with a plurality of second protrusions extending along the first direction and arranged along the second direction; and a shape of the second protrusion is cylindrical lens shaped;
wherein the plurality of second protrusions are closely arranged, or the plurality of second protrusions are arranged at intervals.

22. (canceled)

23. The light guide plate according to claim 21, wherein the light exiting surface is further provided with a plurality of light-adjusting microstructures arranged on surfaces of the second protrusions, and the light-adjusting microstructures are configured to adjust an angle of the light emitted from the light exiting surface.

24. The light guide plate according to claim 23, wherein a shape of the light-adjusting microstructure comprises a cylinder, a triangular pyramid, or a circle.

25. A backlight module, comprising:
the light guide plate according to claim 1;
a light source at a side of the light incident surface of the light guide plate;
a reflective sheet at a side of the bottom surface of the light guide plate; and
a prism sheet at a side of the light exiting surface of the light guide plate.
